(19) United States
(12) Patent Application Publication
(10) Pub. No.: US 2012/0124343 A1
(43) Pub. Date: May 17, 2012

(54) APPARATUS AND METHOD FOR MODIFYING INSTRUCTION OPERAND

(76) Inventors: Ho-Young Kim, Seoul (KR); Soo-Jung Ryu, Hwaseong-si (KR); Moo-Kyoung Chung, Yongin-si (KR); Woong Seo, Hwaseong-si (KR); Young-Chul Cho, Yongin-si (KR)

(21) Appl. No.: 13/163,218

(22) Filed: Jun. 17, 2011

(30) Foreign Application Priority Data
Nov. 16, 2010 (KR) 10-2010-0114045

(51) Int. Cl. G06F 9/30

(52) U.S. Cl. 712/226; 712/E09.016

(57) ABSTRACT

Provided are an apparatus and method for modifying an instruction operand. The apparatus includes a first selector configured to receive first instruction operands and a second selector configured to receive second instruction operands. The apparatus also includes a modification unit configured to select a first instruction operand and a second instruction operand, and to modify the selected first instruction operand and the selected second instruction operand to reduce the operand instructions that are input to the first selector and the second selector.

### CROSS-REFERENCE TO RELATED APPLICATION(S)

This application claims the benefit under 35 U.S.C. §119(a) of Korean Patent Application No. 10-2010-0114045, filed on Nov. 16, 2010, in the Korean Intellectual Property Office, the entire disclosure of which is incorporated herein by reference for all purposes.

### BACKGROUND

1. Field

The following description relates to a technique for reducing the amount of time that it takes to process an instruction using a single instruction multiple data (SIMD) architecture.

2. Description of the Related Art

Processors are largely classified into single-chip processors and embedded processors. For example, single-chip processors such as central processing units (CPUs) can be used in personal computers. For example, embedded processors such as various control chips or smart card chips can be used in system-on-chip (SOC) systems.

Embedded processors may serve as core blocks in a SOC system that performs signal processing by fetching, decoding, and executing instructions, and that reads and writes processed signals. Embedded processors have been widely used in various computation and signal processing operations.

To improve the performance of embedded processors, a parallel-pipeline architecture such as a single-instruction-multiple-data (SIMD) architecture or multiple-instruction-multiple-data (MIMD) architecture, have been adopted. The SIMD architecture is characterized by processing multiple data using a single instruction. The MIMD architecture is characterized by processing multiple data using multiple instructions. The processing of instructions using the SIMD or MIMD architecture may often be delayed for various reasons.

### SUMMARY

In one general aspect, there is provided an apparatus for modifying an instruction operand, the apparatus including a first selector configured to receive first instruction operands, a second selector configured to receive second instruction operands, and a modification unit configured to select at least one instruction operand from the first instruction operands and the second instruction operands, and configured to modify at least one of an input path and a type of the at least one selected instruction operand.

The at least one selected instruction operand may be a selected first instruction operand, and the modification unit may modify the selected first instruction operand that is input to the first selector to be the same in type as another first instruction operand that is already input to the first selector to reduce the type of instructions operands that are input to the first selector.

The apparatus may further comprise a detection unit configured to detect types of the first instruction operands and the second instruction operands, wherein the modification unit selects a first instruction operand and a second instruction operand and modifies the input paths of the selected first instruction operand and the selected second instruction operands based on the detected types, such that the selected first instruction operand is input to the second selector and such that the selected second instruction operand is input to the first selector, to reduce the type of instruction operands that are input to the first selector and the second selector.

The apparatus may further comprise a detection unit configured to detect types of the first instruction operands and the second instruction operands, wherein the modification unit is further configured to modify the types of the selected first and second instruction operands by modifying the definition of the selected at least one instruction operand to reduce the type of instruction operands that are input to the first selector and/or the second selector.

If there is only first instruction operands, the modification unit may control a compiler to generate second compiler operands that are a duplicate of the first compiler operands, and the second compiler operands may be input to the second selector.

The modification unit may select a first instruction operand, and modify the selected first instruction operand with a second instruction operand that corresponds to the selected first instruction operand's duplicate, to reduce the type of instruction operands that are input to the first selector.

The apparatus may further comprise a quantity calculation unit configured to calculate a number of types of first instruction operands and second instruction operands whenever the modification unit performs an instruction operand modification operation, a determination unit configured to determine whether the instruction operand modification operation has been performed for all combinations of modifying instruction operands, and an extraction unit configured to extract instruction operand combinations if the instruction operand modification operation has been performed for all the combinations of modifying instruction operands and the number of types of instruction operands obtained by the instruction operand modification operation reaches a minimum.

In another aspect, there is provided a method of modifying an instruction operand, the method including loading first instruction operands, which are input to a first selector, and second instruction operands, which are input to a second selector, selecting at least one instruction operand from the first instruction operands and the second instruction operands, and modifying at least one of input paths and types of the selected at least one instruction operand.

The at least one selected instruction operand may be a selected first instruction operand, and the modifying may comprise modifying the selected first instruction operand to be the same in type as another first instruction operand that is already input to the first selector, to reduce the type of instructions operands that are input to the first selector.

The method may further comprise detecting types of the first instruction operands and the second instruction operands, wherein the modifying comprises selecting a first instruction operand and a second instruction operand and modifying the input paths of the selected first instruction operand and the selected second instruction operand based on the detected types, such that the selected first instruction operand is input to the second selector and such that the selected second instruction operand is input to the first selector, to reduce the type of instruction operands that are input to the first selector and the second selector.

The method may further comprise detecting types of the first instruction operands and the second instruction operands, wherein the modifying of the at least one of the input paths and types of the selected instruction operand comprises modifying the types of the selected instruction operand by modifying a definition of the selected instruction operand to reduce the type of instruction operands that are input to the first selector and the second selector.

If there is only first instruction operands, the modifying may comprise generating second compiler operands that are a duplicate of the first compiler operands, and the second compiler operands may be input to the second selector.

The modifying may comprise selecting a first instruction operand, and modifying the selected first instruction operand with a second instruction operand that corresponds to the selected first instruction operand's duplicate, to thereby reduce the amount of instruction operands that are input to the first selector.

The method may further comprise calculating a number of types of first instruction operands and second instruction operands whenever an instruction operand modification operation is performed, determining whether the instruction operand modification operation has been performed for all combinations of modifying instruction operands, and extracting instruction operand combinations if the instruction operand modification operation has been performed for all the combinations of modifying instruction operands and the number of types of instruction operands obtained by the instruction operand modification operation reaches a minimum.

In another aspect, there is provided an apparatus for modifying instruction operands, the apparatus including a divider to divide a first operand into a plurality of first instruction operands, and to divide a second operand into a plurality of second instruction operands, a first selector for receiving the plurality of first instruction operands as an input, a second selector for receiving the plurality of second instruction operands as an input, and a modifier for selecting at least one instruction operand from the plurality of first instruction operands and the plurality of second instruction operands, and for modifying the at least one selected instruction operand to reduce the type of instruction operands that are input to the first selector and/or the second selector.

The apparatus may further comprise a detector that detects a type of instruction operand for each of the plurality of first instruction operands and for each of the plurality of second instruction operands.

The at least one selected instruction operand may be a first instruction operand and a second instruction operand, and the detector may detect that the selected first instruction operand is an instruction operand that is the same in type as an instruction operand of a second operand instruction that is already input to the second selector, the detector may detect that the selected second instruction operand is an instruction operand that is the same in type as an instruction operand of a first instruction operand already input to the first selector, and the modifier may modify an input path of the selected first instruction operand such that the selected first instruction operand is input to the second selector, and the modifier may modify an input path of the selected second instruction operand such that the selected second instruction operand is input to the first selector, to reduce the type of operand instructions input to the first selector and the second selector.

The selected instruction operand may be a first instruction operand, and the modifier may swap the selected first instruction operand with a second instruction operand to reduce the types of instruction operands that are input to the first selector while still achieving the desired operational result.

In response to the second plurality of instruction operands not being input to the second selector, the modifier may duplicate the first plurality of instruction operands to generate the second plurality of instruction operands, and the generated second plurality of instruction operands may be input to the second selector.

The modifier may modify a selected first instruction operand with a second operand instruction that corresponds to a duplicate of the selected first instruction operand, to reduce the type of instruction operands that are input to the first selector.

Other features and aspects may be apparent from the following detailed description, the drawings, and the claims.

### BRIEF DESCRIPTION OF THE DRAWINGS

FIG. 1 is a diagram illustrating an example of an apparatus for changing an instruction operand.

FIG. 2 is a table illustrating examples of definitions of instruction operands.

FIG. 3 is a table illustrating examples of the classification of the instruction operands shown in FIG. 2.

FIG. 4 is a diagram illustrating examples of selectors and adders that may be used to process the instruction operands shown in FIG. 3.

FIGS. 5, 6, and 7 are diagrams illustrating examples of modifying instruction operands.

FIG. 8 is a table illustrating examples of instruction operand combinations that are extracted by an extraction unit.

FIG. 9 is a flowchart illustrating an example of a method of modifying an instruction operand.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

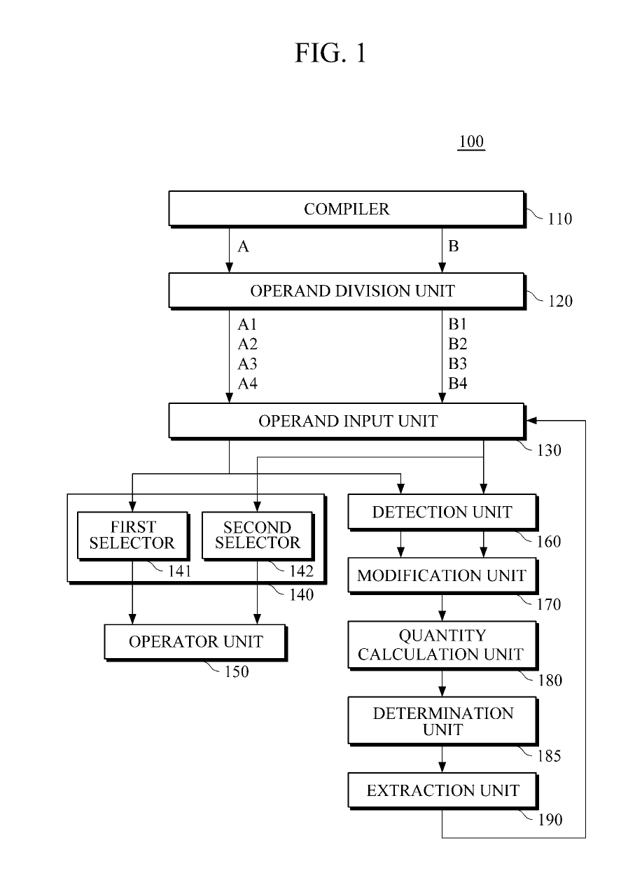

FIG. 1 illustrates an example of an apparatus for modifying an instruction operand. The apparatus may be or may be included in a terminal such as a mobile terminal, a computer, a personal digital assistant (PDA), a smart phone, an MP3 player, and the like.

Referring to FIG. 1, apparatus 100 for modifying an instruction operand (apparatus) includes a compiler 110, an operand division unit 120, an operand input unit 130, a selector unit 140, an operator unit 150, a detection unit 160, a modification unit 170, a quantity calculation unit 180, a determination unit 185, and an extraction unit 190.

The compiler 110 may input an instruction and a compiler operand to the operand division unit 120. For example, the term ‘operand’ indicates an address in memory in which a data value or data subject to computation is stored. For example, the term ‘compiler operand’ indicates an operand that is input to the operand division unit 120 by the compiler 110.

The operand division unit 120 may divide the compiler operand input by the compiler 110 into a plurality of instruction operands, and may input the instruction operands to the operand input unit 130. For example, the term ‘instruction operand’ indicates an operand that is included in an instruction. For example, if the operand division unit 120 receives compiler operands A and B from the compiler 110, the operand division unit 120 may divide compiler operand A into instruction operands A1, A2, A3, and A4 and may divide compiler operand B is into instruction operands B1, B2, B3, and B4.

For example, if compiler operand A is 64-bit data, the operand division unit 120 may divide compiler operand A into a plurality of 16-bit segments to obtain instruction operands A1, A2, A3, and A4. As another example, if compiler operand A is a 64-bit address, the operand division unit 120 may divide compiler operand A into a plurality of 16-bit addresses to obtain instruction operands A1, A2, A3, and A4. The operand division unit 120 may divide compiler operand B into a plurality of instruction operands using the same method that is used to divide compiler operand A.

The operand input unit 130 may input instruction operands that are provided by the operand division unit 120 to the selector unit 140. For example, the operand input unit 130 may extract first instruction operands that are to be input to a first selector 141, and second instruction operands that are to be input to a second selector 142. There may be some operands that are the same between the first instruction operands and the second instruction operands. The operand input unit 130 may input the first instruction operands to the first selector 141 and may input the second instruction operands to the second selector 142.

The operand input unit 130 may input the instruction operands that are provided by the operand division unit 120 to the detection unit 160.

The selector unit 140 may input one of the instruction operands that are provided by the operand input unit 130 to the operator unit 150. For example, the first selector 141 may select a first instruction operand and may input the selected first instruction operand to the operator unit 150. The second selector 142 may select a second instruction operand and may input the selected second instruction operand to the operator unit 150. As an example, the selector unit 140 may be a multiplexer.

The operator unit 150 may perform an operation on the instruction operands that are input by the selector unit 140. For example, the operator unit 150 may perform an operation on two instruction operands that are input by the first and second selectors 141 and 142.

The detection unit 160 may detect the types of the instruction operands that are input to the operand input unit 130. For example, the detection unit 160 may detect the types of the first instruction operands that are input to the first selector 141 and the types of the second instruction operands that are input to the second selector 142. For example, if the instruction operands input to the operand input unit 130 are data values, the detection unit 160 may identify instruction operands that have the same data value as being of the same type, and may identify instruction operands that have different data values as being of different types.

The modification unit 170 may select a first instruction operand or a second instruction operand, and may modify the input path and type of the selected instruction operand. For example, the modification unit 170 may modify the input path of the selected instruction operand to the selector unit 140 based on the type of the selected instruction operand that is detected by the detection unit 160. As another example, the modification unit 170 may modify the selected instruction operand by modifying the definition of an instruction corresponding to the selected instruction operand.

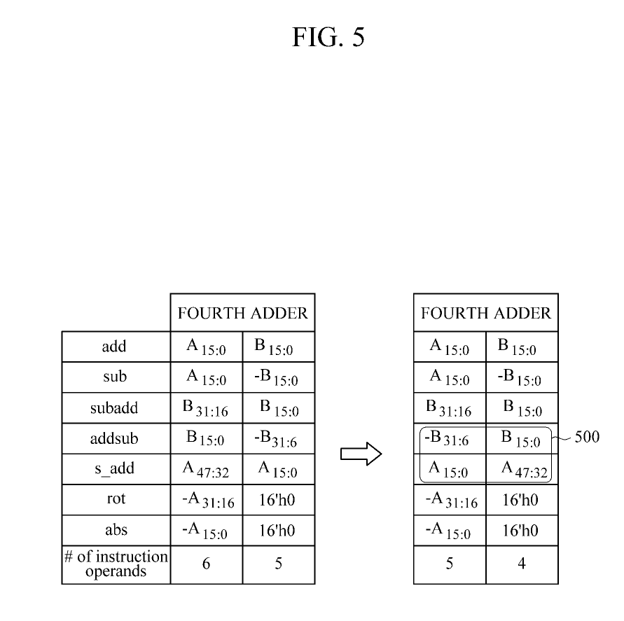

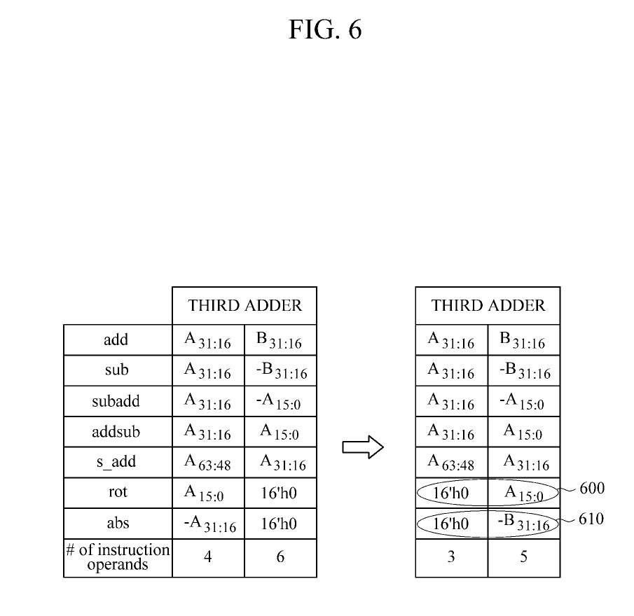

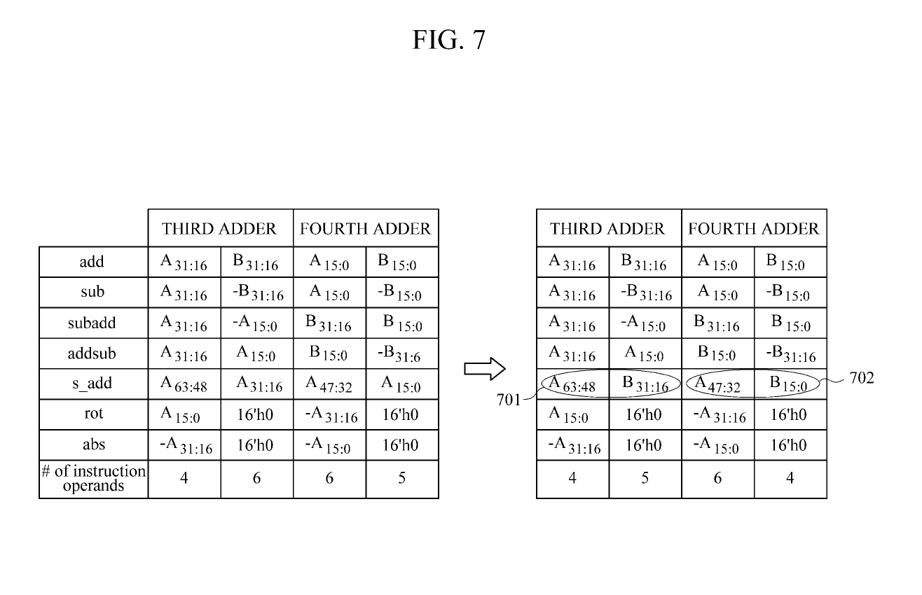

As another example, if there is only one compiler operand (i.e., a first compiler operand), the compiler 110 may generate a second compiler operand that is the same as the first compiler operand, and may input the first and second compiler operands to the operand division unit 120. In this example, the modification unit 170 may modify the types of the instruction operands as is further described herein with reference to FIGS. 5, 6, and 7.

The modification unit 170 may modify at least one instruction operand that is input thereto so that it is the same in type as the other instruction operands. For example, if there are X, Y, and Z instruction operands, the modification unit 170 may modify the Z command operand into a Y instruction operand so that there are only two types of instruction operands X and Y.

The quantity calculation unit 180 may calculate the number of instruction operands. For example, the quantity calculation unit 180 may calculate the number of instruction operands each time the modification unit 170 performs an instruction operand modification. For example, the quantity calculation unit 180 may calculate the number of types of instruction operands that are input to the selector unit 140.

The determination unit 185 may determine whether all of the combinations for modifying instruction operands have been subject to instruction operand minimization. For example, the determination unit 185 may determine whether an instruction operand modification has been performed for all the combinations for modifying instruction operands. In this example, the combinations for modifying instruction operands may be determined based on the number of types of instruction operands and the number of operand modification techniques that may be used to modify instruction operands. If all combinations for modifying instruction operands have not been subjected to instruction operand modification, the modification unit 170 may continue to perform instruction operand modification.

In response to the number of types of instruction operands obtained by instruction operand modification reaching a minimum value, the extraction unit 190 may extract an instruction operand combination. For example, term ‘instruction operand combination’ indicates a set of modified instruction operands. The minimization of the number of types of instruction operands by instruction operand modification may be interpreted as the minimization of the number of instruction operands that are to be input to the selector unit 140.

The extraction unit 190 may input the extracted instruction operand combination to the operand input unit 130. The operand input unit 130 may input an instruction operand to the selector unit 140 based on the instruction operand combination that is input operand input unit 130 by the extraction unit 190. By reducing the number of instruction operands to be input to the selector unit 140, the structure of the selector unit 140 may be simplified. For example, if the selector unit 140 is a multiplexer, the number of stages of the multiplexer for processing input instruction operands may be reduced by reducing the number of input instruction operands. Accordingly, the time used for the multiplexer to process the input instruction operands may be reduced.

For example, it is possible to simplify the structure of a selector unit by modifying instruction operands to reduce the number of instruction operands that are to be input to the selector unit.

In addition, it is possible to reduce the time used for a selector unit to process instruction operands by modifying instruction operands to reduce the number of instruction operands that are to be input to the selector unit.

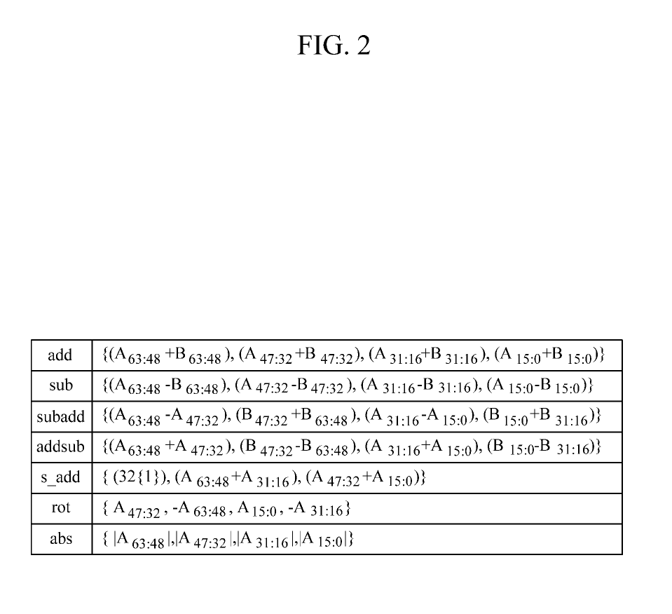

FIG. 2 illustrates an example of the definitions of instruction operands.

Referring to FIG. 2, instruction operand A_{63:48} is a 16-bit instruction operand that includes the 63^{rd} to 48^{th} data in compiler operand A, instruction operand A_{47:32} is a 16-bit instruction operand that includes the 47^{th} to 32^{nd} data in compiler operand A, instruction operand A_{31:16} is a 16-bit instruction operand that includes the 31^{st} to 16^{th} data in compiler operand A, instruction operand A_{15:0} is a 16-bit instruction operand that includes the 15^{th} to 0^{th} data in compiler operand A. In this example, the instruction operand B_{63:48} is a 16-bit instruction operand that includes the 63^{rd} to 48^{th} data in compiler operand B, instruction operand B_{47:32} is a 16-bit instruction operand that includes the 47^{th} to 32^{nd} data in compiler operand B, instruction operand B_{31:16} is a 16-bit instruction operand that includes the 31^{st} to 16^{th} data in compiler operand B, and instruction operand B_{15:0} is a 16-bit instruction operand that includes the 15^{th} to 0^{th} data in compiler operand B.

In this example, reference symbol ‘32{1}’ indicates addition of the hexadecimal values of hffff and h0. Reference symbol ‘| |’ indicates an absolute value operation. It should be appreciated that the compiler operands and the instruction operands shown in FIG. 2 are merely examples, and may have various other sizes than those set forth herein.

Referring to FIG. 2, instruction ‘add’ is an instruction to perform addition on 16-bit instruction operands. Instruction ‘sub’ is an instruction to perform subtraction on 16-bit instruction operands. Instruction ‘subadd’ is an instruction to perform addition on some 16-bit instruction operands and subtraction on the other 16-bit instruction operands. Instruction ‘addsub’ is an instruction to perform addition on some 16-bit instruction operands and subtraction on the other 16-bit instruction operands. Instruction ‘s_add’ is an instruction to add the hexadecimal values of hffff and h0 and add 16-bit instruction operands. Instruction ‘rot’ may include 16-bit instruction operands that have positive or negative values, and is an instruction to add the 16-bit instruction operands and 0. Instruction ‘abs’ is an instruction to perform an absolute value operation.

The instructions shown in FIG. 2 are examples of modifying an instruction operand. The instructions may be defined in various manners, for example, by programmers.

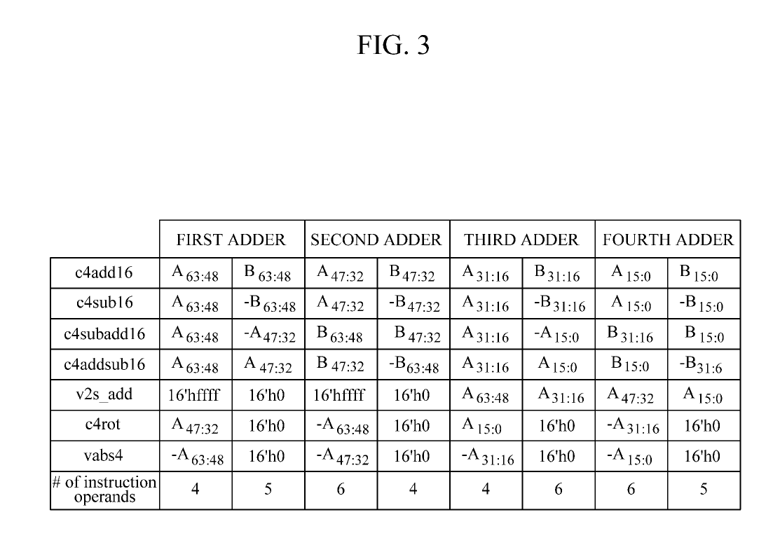

FIG. 3 illustrates an example of the classification of the instruction operands shown in FIG. 2. The classification may be performed by an operator. In this example, the operators may be adders.

Referring to FIG. 3, reference character 16′hffff indicates the hexadecimal value of hffff, and reference character 16′h0 indicates the hexadecimal value of 0. For example, four adders (i.e., first, second, third, and fourth adders) may be used to compute instruction operands.

The instruction operands shown in FIG. 2 may be classified by an operator, and each operator may be marked with the number of instruction operands that are allocated thereto. A group of instruction operands that are allocated to each operator are referred to as an instruction operand combination.

In this example, the number of instruction operands to be input to a first port of the first adder by the selector unit 140 is 4, and the number of instruction operands to be input to a second port of the first adder by the selector unit 140 is 5.

Also in this example, the number of instruction operands to be input to a first port of the second adder by the selector unit 140 is 6, and the number of instruction operands to be input to a second port of the second adder by the selector unit 140 is 4.

Also in this example, the number of instruction operands to be input to a first port of the third adder by the selector unit 140 is 4, and the number of instruction operands to be input to a second port of the third adder by the selector unit 140 is 6.

Also in this example, the number of instruction operands to be input to a first port of the fourth adder by the selector unit 140 is 6, and the number of instruction operands to be input to a second port of the fourth adder by the selector unit 140 is 5.

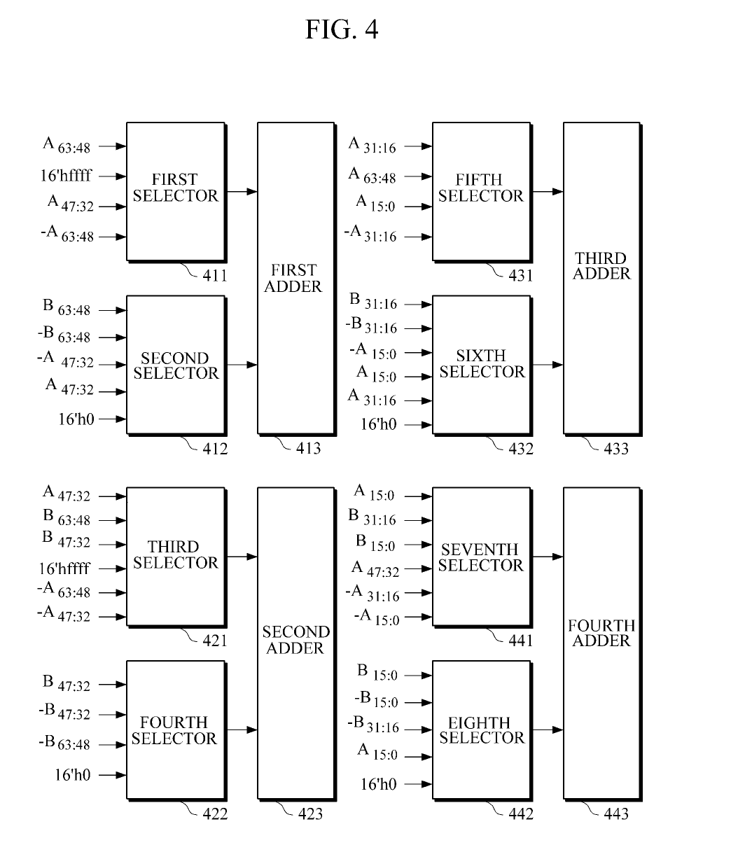

FIG. 4 illustrates examples of selectors and adders that may be used to process the instruction operands shown in FIG. 3.

Referring to FIGS. 3 and 4, eight selectors (i.e., first, second, third, fourth, fifth, sixth, seventh, and eighth selectors 411, 412, 421, 422, 431, 432, 441, and 442) and four adders (i.e., first, second, third, and fourth adders 413, 423, 433, and 443) may be used to process the instruction operands that are shown in FIG. 3.

First instruction operands (i.e., A_{63:48}, 16′hffff, A_{47:32}, and −A_{63:48}) may be input to the first selector 411. The first selector 411 may select one of the first instruction operands that is input thereto, and may input the selected instruction operand to the first adder 413.

Second instruction operands (i.e., B_{63:48}, −B_{63:48}, −A_{47:32}, A_{47:32}, and 16′h0) may be input to the second selector 412. The second selector 412 may select one of the second instruction operands that is input thereto and may input the selected instruction operand to the first adder 413.

The first adder 413 may add the first and second instruction operands that are input by the first and second selectors 411 and 412, respectively. For example, if the first instruction operand selected by and input to the first adder 413 by the first selector 411 is A_{63:48}, and the second instruction operand selected by and input to the first adder 413 by the second selector 412 is B_{63:48}, the first selector 411 may add the instruction operands A_{63:48} and B_{63:48}.

Third instruction operands (i.e., A_{47:32}, B_{63:48}, B_{47:32}, 16′hffff, −A_{63:48}, and −A_{47:32}) may be input to the third selector 421. The third selector 421 may select one of the third instruction operands that is input thereto, and may input the selected third instruction operand to the second adder 423.

Fourth instruction operands (i.e., B_{47:32}, −B_{47:32}, −B_{63:48}, and 16′h0) may be input to the fourth selector 422. The fourth selector 422 may select one of the fourth instruction operands that is input thereto, and may input the selected fourth instruction operand to the second adder 423.

The second adder 423 may add the third and fourth instruction operands that are input thereto by the third and fourth selectors 421 and 422, respectively.

Fifth instruction operands (i.e., A_{31:16}, A_{63:48}, A_{15:0}, and −A_{31:16}) may be input to the fifth selector 431. The fifth selector 431 may select one of the fifth instruction operands that are input thereto, and may input the selected fifth instruction operand to the third adder 433.

Sixth instruction operands (i.e., B_{31:16}, −B_{31:16}, A_{15:0}, A_{31:16}, and 16′h0) may be input to the sixth selector 432. The sixth selector 432 may select one of the sixth instruction operands that are input thereto, and may input the selected sixth instruction operand to the third adder 433.

The third adder 433 may add the fifth and sixth instruction operands that are input thereto by the fifth and sixth selectors 431 and 432, respectively.

Seventh instruction operands (i.e., A_{15:0}, B_{31:16}, B_{15:0}, A_{47:32}, −A_{31:16}, and −A_{15:0}) may be input to the seventh selector 441. The seventh selector 441 may select one of the seventh instruction operands that are input thereto, and may input the selected seventh instruction operand to the fourth adder 443.

Eighth instruction operands (i.e., B_{15:0}, −B_{15:0}, −B_{31:16}, A_{15:0}, and 16′h0) may be input to the eighth selector 442. The eighth selector 442 may select one of the eighth instruction operands that are input thereto, and may input the selected eighth instruction operand to the fourth adder 443.

The fourth adder 443 may add the seventh and eighth instruction operands input thereto by the seventh and eighth selectors 441 and 442, respectively.

FIGS. 5, 6, and 7 illustrate examples of modifying instruction operands.

Referring to FIGS. 1, 4, and 5, the modification unit 170 may modify the path of an instruction operand that is input to the selector unit 140, based on a detected type of the instruction operand that may be detected by the detection unit 160. The modification of the input path of an instruction operand may be referred to as operand substitution.

For example, the modification unit 170 may modify the input paths of instruction operands corresponding to instructions ‘addsub’ and ‘s_add,’ from among other instruction operands to be input to the seventh and eighth selectors 441 and 442. A commutative rule may is be applied between the instruction operands that correspond to instructions ‘addsub’ and ‘s_add.’Accordingly, operation results obtained before and after the modification of the input paths of the instruction operands corresponding to instructions ‘addsub’ and ‘s_add’ may be the same.

For example, the modification unit 170 may modify the input paths of instruction operands B_{15:0} and −B_{31:16}, which correspond to instruction ‘addsub.’ As an example, the modification unit 170 may modify the input path of instruction operand B_{15:0} such that instruction operand B_{15:0} is input to the eighth selector 442, and may modify the input path of instruction operand −B_{31:16} such that instruction operand B_{31:16} is input to the seventh selector 441. The modification unit 170 may modify instruction operand −B_{31:16} to be of the same type as instruction operand B_{15:0} included in instruction ‘subadd,’ thereby reducing the number of types of instruction operands that are input to the eighth selector 442 to four (i.e., B_{15:0}, −B_{15:0}, A_{15:0}, and 16′h0).

As another example, the modification unit 170 may modify the input paths of instruction operands A_{47:32} and A_{15:0} that correspond to instruction ‘s_add.’ The modification unit 170 may modify the input path of instruction operand A_{47:32} such that instruction operand A_{47:32} is input to the eighth selector 442, and may modify the input path of instruction operand A_{15:0} such that instruction operand A_{15:0} is input to the seventh selector 441. The modification unit 170 may modify instruction operand A_{47:32} to be of the same type as instruction operand A_{15:0} included in instruction ‘sub,’ thereby reducing the number of types of instruction operands that are input to the eighth selector 442 to five (i.e., A_{15:0}, B_{31:16}, B_{15:0}, −A_{31:16}, and −A_{15:0}).

Referring to FIGS. 1, 4, and 6, the modification unit 170 may modify an instruction operand by modifying the definition of an instruction that includes the instruction operand. This type of instruction operand modification is referred to as operand swapping. For example, the modification unit 170 may modify the definition of instruction ‘add.’ The modification unit 170 may modify instruction ‘add A B’ into instruction ‘add B A’ through operand swapping so that instruction operand B, instead of instruction operand A, is input to the first selector 141, and that instruction A, instead of instruction operand B, is input to the second selector 142.

For example, the modification unit 170 may modify instruction operands corresponding to instructions rot and abs, from among other instruction operands to be input to the fifth and sixth selectors 431 and 432, through operand swapping, as indicated by reference numeral 600. By operand swapping, the number of types of instruction operands to be input to the fifth selector 431 is reduced to three (i.e., A_{31:16}, A_{63:48}, and 16′h0).

As another example, the modification unit 170 may modify instruction operand −A_{31:16} corresponding to instruction ‘abs’ into instruction operand −B_{31:16} by modifying the definition of instruction ‘abs,’ as indicated by reference numeral 610. In this example, the compiler 110 may generate compiler operand B that is the same as the compiler operand A, and may input the generated compiler operand to the operand division unit 120 so that a data value corresponding to instruction operand −A_{31:16} becomes the same as a data value corresponding to instruction operand −B_{31:16}. As a result, the number of types of instruction operands input to the sixth selector 432 may be reduced to five (i.e., B_{31:16}, −B_{31:16}, −A_{15:0}, A_{15:0}, and A_{31:16}).

Referring to FIGS. 1, 4, and 7, if the number of compiler operands input to the operand division unit 120 is 1 and the compiler operand input to the operand division unit 120 is a first compiler operand, the compiler 110 may generate a second compiler operand that is the same as the first compiler operand. The compiler 110 may input the first and second compiler operands to the operand division unit 120. In this example, the operand division unit 120 may divide each of the first and second compiler operands into a plurality of instruction operands, and may input the instruction operands obtained by dividing each of the first and second compiler operands to the operand input unit 130.

The operand input unit 130 may input the instruction operands provided by the operand division unit 120 to the selector unit 140. In this example, the modification unit 170 may modify one of a plurality of instruction operands, which are to be selected by the selector unit 140 when there is only one compiler operand (i.e., the first compiler operand) input to the operand division unit 120, to be the same as one of the instruction operands obtained by dividing the second compiler operand. This type of instruction operand modification is referred to as operand duplication.

For example, instruction ‘s_add’ may only include instruction operands A_{63:48}, A_{47:32}, A_{31:16}, and A_{15:0}, which are obtained by dividing only one compiler operand (i.e., compiler operand A). If only compiler operand A is input to the operand division unit 120, the compiler 110 may generate compiler operand B that is the same as compiler operand A, and may input compiler operands A and B to the operand division unit 120. The operand division unit 120 may divide compiler operand A into first instruction operands (i.e., A_{63:48}, A_{47:32}, A_{31:16}, and A_{15:0}) and compiler operand B into second instruction operands (i.e., B_{63:48}, B_{47:32}, B_{31:16}, and B_{15:0}), and may input the first instruction operands and the second instruction operands to the operand input unit 130.

The operand input unit 130 may input the first instruction operands to the fifth and seventh selectors 421 and 431 and the second instruction operands to the sixth and eighth selectors 422 and 432. The fifth selector 421 may select one of the first instruction operands that is input thereto, for example, instruction operand A_{63:48}, and may input instruction operand A_{63:48} to the operator unit 150. The sixth selector 422 may select one of the second instruction operands that is input thereto, for example, instruction operand B_{31:16}, and may input instruction operand B_{31:16} to the operator unit 150. The seventh selector 431 may select one of the first instruction operands that is input thereto, for example, instruction operand A_{47:32}, and may input instruction operand instruction operand A_{47:32} to the operator unit 150. The eighth selector 432 may select one of the second instruction operands that is input thereto, for example, instruction operand B_{15:0}, and may input instruction operand B_{15:0} to the operator unit 150. The first instruction operands, i.e., A_{63:48}, A_{47:32}, A_{31:16}, and A_{15:0}, may have the same data values as their respective instruction operands, i.e., B_{63:48}, B_{47:32}, B_{31:16}, and B_{15:0}.

The modification unit 170 may modify one of instruction operands A_{63:48} and A_{31:16}, which are to be selected by the selector unit 140 when there is only one compiler operand (i.e., the first compiler operand) input to the operand division unit 120, for example, instruction operand A_{31:16}, to be the same as one of the instruction operands obtained by dividing the second compiler operand, for example, instruction operand B_{31:16}. Instruction operand B_{31:16} corresponds to instruction operand A_{31:16}, and instruction operands A_{31:16} and B_{31:16} have the same data values.

The modification unit 170 may modify one of instruction operands A_{47:32} and A_{15:0}, which are to be selected by the selector unit 140 when there is only one compiler operand (i.e., the first compiler operand) input to the operand division unit 120, for example, instruction operand A_{15:0}, to be the same as one of the instruction operands obtained by dividing the second compiler operand, for example, instruction operand B_{15:0}. Instruction operand B_{15:0} corresponds to instruction operand A_{15:0}, and instruction operands A_{15:0} and B_{15:0} have the same data values. Thus, operation results before and after the modification of the instruction operands may be the same.

For example, the modification unit 170 may modify instruction operands using operand substitution, operand swapping, and/or operand duplication.

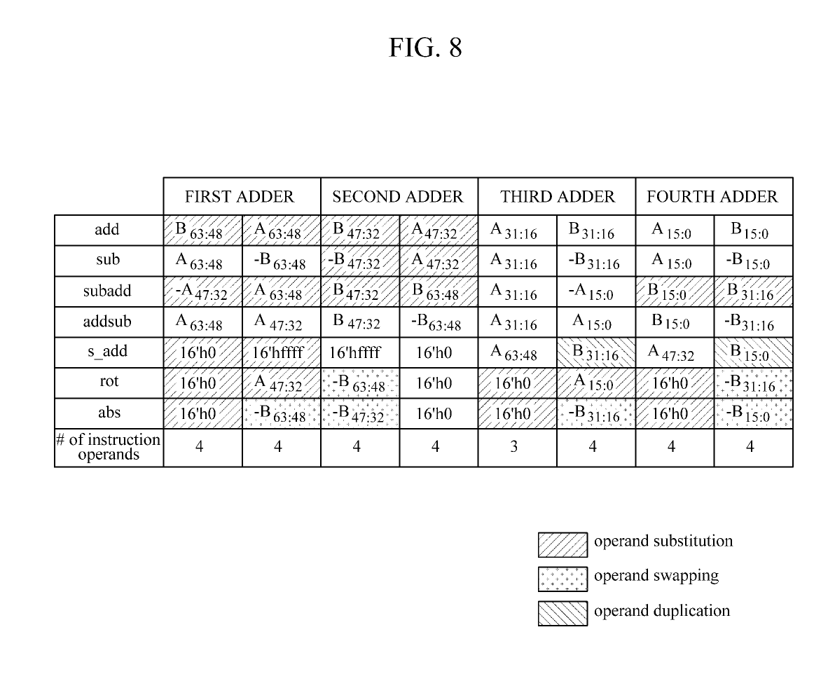

FIG. 8 illustrates an example of instruction operand combinations extracted by the extraction unit 190 illustrated in FIG. 1. In this example, the number of types of instruction operands obtained by instruction operand modification reaches a minimum.

Referring to FIGS. 1 and 8, in this example, the modification unit 170 modifies instruction operands −A_{63:48} and 16′h0 of instruction ‘abs’ that is input to the first adder 413, using operand substitution, and modifies instruction operand −A_{63:48} into −B_{63:48} using operand swapping.

The modification unit 170 may modify the instruction operands shown in FIG. 3 using operand substitution, operand swapping, and/or operand duplication. The quantity calculation unit 180 may calculate the number of types of instruction operands. For example, whenever the modification unit 170 performs instruction operand modification, the quantity calculation unit 180 may calculate the number of types of instruction operands. The extraction unit 190 may extract instruction operand combinations if the result of the calculation performed by the quantity calculation unit 180 reaches a minimum.

The number of types of instruction operands shown in FIG. 8 is reduced, as compared to the number of types of instruction operands shown in FIG. 3.

As described herein, it is possible to reduce the number of types of instruction operands that are input to a selector unit and thus it is possible to simplify the structure of the selector unit by modifying instruction operands.

In addition, it is possible to reduce the time used for the selector unit to process instruction operands by modifying the instruction operands so as to reduce the number of types of instruction operands that are input to the selector unit.

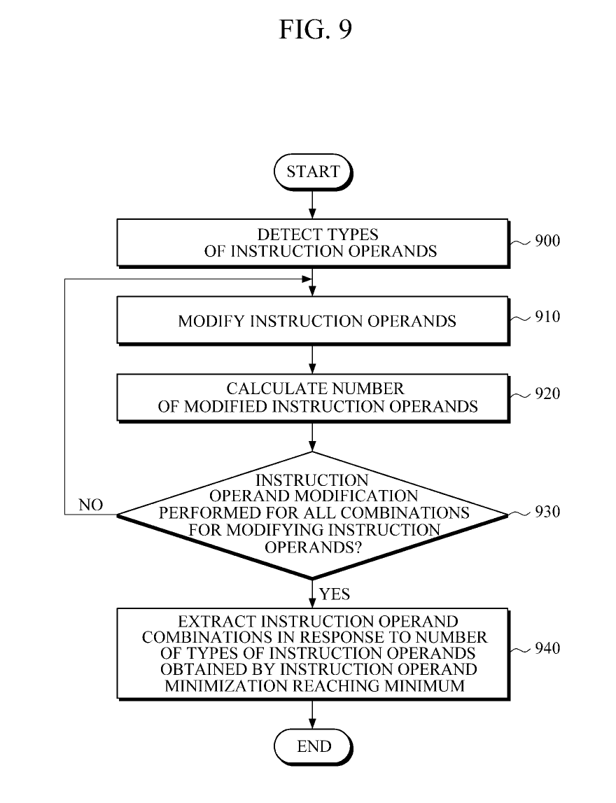

FIG. 9 illustrates an example of a method of modifying an instruction operand.

Referring to FIGS. 1 and 9, the types of instruction operands may be detected, in 900. For example, the detection unit 160 may detect the types of first instruction operands that are input to the first selector 141, and detect the types of second instruction operands that are input to the second selector 142.

In 910, the first instruction operands and the second instruction operands may be loaded, at least one of the first instruction operands and at least one of the second instruction operands may be selected, and at least one of the input paths and types of the selected first and second instruction operands may be modified. For example, the modification unit 170 may modify the paths of the instruction operands that are input to the selector unit 140, based on their types detected by the detection unit 160. As another example, the modification unit 170 may modify the definition of an instruction, and may modify instruction operands corresponding to the instruction. As another example, if there is only one compiler operand (i.e., first compiler operand), the compiler 110 may additionally input another compiler operand to the operand division unit 120, and the modification unit 170 may perform instruction operand modification. The modification unit 170 may modify at least one of the instruction operands input thereto so that the modified instruction operand becomes the same in type as the other instruction operands.

Each time the modification unit 170 performs an instruction operand modification operation, in 920 the number of types of instruction operands resulting from the instruction operand modification operation are calculated. For example, the quantity calculation unit 180 may calculate the number of types of first instruction operands and the number of types of second instruction operands.

In 930, a determination is made as to whether all combinations for modifying instruction operands have been subject to instruction operand modification. For example, the determination unit 185 may determine whether instruction operand modification has been performed for all the combinations for modifying instruction operands. If not all the all combinations for modifying instruction operands have yet been subject to instruction operand modification, instruction operand modification continue to be performed, in 910. On the other hand, if all the all combinations for modifying instruction operands have been subject to instruction operand modification and the number of types of instruction operands obtained by instruction operand modification reaches a minimum, instruction operand combinations are extracted, in 940. The number of instruction operands included in each of the instruction operand combinations extracted in operation 940 may be less than the number of instruction operands included in an existing instruction operand combination.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a is decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for modifying an instruction operand, the apparatus comprising:
a first selector configured to receive first instruction operands;
a second selector configured to receive second instruction operands; and
a modification unit configured to select at least one instruction operand from the first instruction operands and the second instruction operands, and configured to modify at least one of an input path and a type of the at least one selected instruction operand.

2. The apparatus of claim 1, wherein the at least one selected instruction operand is a selected first instruction operand, and the modification unit modifies the selected first instruction operand that is input to the first selector to be the same in type as another first instruction operand that is already input to the first selector to reduce the type of instructions operands that are input to the first selector.

3. The apparatus of claim 1, further comprising a detection unit configured to detect types of the first instruction operands and the second instruction operands,
wherein the modification unit selects a first instruction operand and a second instruction operand and modifies the input paths of the selected first instruction operand and the selected second instruction operands based on the detected types, such that the selected first instruction operand is input to the second selector and such that the selected second instruction operand is input to the first selector, to reduce the type of instruction operands that are input to the first selector and the second selector.

4. The apparatus of claim 1, further comprising a detection unit configured to detect types of the first instruction operands and the second instruction operands,
wherein the modification unit is further configured to modify the types of the selected first and second instruction operands by modifying the definition of the selected at least one instruction operand to reduce the type of instruction operands that are input to the first selector and/or the second selector.

5. The apparatus of claim 1, wherein, if there is only first instruction operands, the modification unit controls a compiler to generate second compiler operands that are a duplicate of the first compiler operands, and the second compiler operands are input to the second selector.

6. The apparatus of claim 5, wherein the modification unit selects a first instruction operand, and modifies the selected first instruction operand with a second instruction operand that corresponds to the selected first instruction operand's duplicate, to reduce the type of instruction operands that are input to the first selector.

7. The apparatus of claim 1, further comprising:
a quantity calculation unit configured to calculate a number of types of first instruction operands and second instruction operands whenever the modification unit performs an instruction operand modification operation;
a determination unit configured to determine whether the instruction operand modification operation has been performed for all combinations of modifying instruction operands; and
an extraction unit configured to extract instruction operand combinations if the instruction operand modification operation has been performed for all the combinations of modifying instruction operands and the number of types of instruction operands obtained by the instruction operand modification operation reaches a minimum.

8. A method of modifying an instruction operand, the method comprising:
loading first instruction operands, which are input to a first selector, and second instruction operands, which are input to a second selector;
selecting at least one instruction operand from the first instruction operands and the second instruction operands; and
modifying at least one of input paths and types of the selected at least one instruction operand.

9. The method of claim 8, wherein the at least one selected instruction operand is a selected first instruction operand, and the modifying comprises modifying the selected first instruction operand to be the same in type as another first instruction operand that is already input to the first selector, to reduce the type of instructions operands that are input to the first selector.

10. The method of claim 8, further comprising detecting types of the first instruction operands and the second instruction operands,
wherein the modifying comprises selecting a first instruction operand and a second instruction operand and modifying the input paths of the selected first instruction operand and the selected second instruction operand based on the detected types, such that the selected first instruction operand is input to the second selector and such that the selected second instruction operand is input to the first selector, to reduce the type of instruction operands that are input to the first selector and the second selector.

11. The method of claim 8, further comprising detecting types of the first instruction operands and the second instruction operands,
wherein the modifying of the at least one of the input paths and types of the selected instruction operand comprises modifying the types of the selected instruction operand by modifying a definition of the selected instruction operand to reduce the type of instruction operands that are input to the first selector and the second selector.

12. The method of claim 8, wherein, if there is only first instruction operands, the modifying comprises generating second compiler operands that are a duplicate of the first compiler operands, and the second compiler operands are input to the second selector.

13. The method of claim 12, wherein the modifying comprise selecting a first instruction operand, and modifying the selected first instruction operand with a second instruction operand that corresponds to the selected first instruction operand's duplicate, to thereby reduce the amount of instruction operands that are input to the first selector.

14. The method of claim 8, further comprising:
calculating a number of types of first instruction operands and second instruction operands whenever an instruction operand modification operation is performed;
determining whether the instruction operand modification operation has been performed for all combinations of modifying instruction operands; and
extracting instruction operand combinations if the instruction operand modification operation has been performed for all the combinations of modifying instruction operands and the number of types of instruction operands obtained by the instruction operand modification operation reaches a minimum.

15. An apparatus for modifying instruction operands, the apparatus comprising:
a divider to divide a first operand into a plurality of first instruction operands, and to divide a second operand into a plurality of second instruction operands;
a first selector for receiving the plurality of first instruction operands as an input;
a second selector for receiving the plurality of second instruction operands as an input; and
a modifier for selecting at least one instruction operand from the plurality of first instruction operands and the plurality of second instruction operands, and for modifying the at least one selected instruction operand to reduce the type of instruction operands that are input to the first selector and/or the second selector.

16. The apparatus of claim 15, further comprising a detector that detects a type of instruction operand for each of the plurality of first instruction operands and for each of the plurality of second instruction operands.

17. The apparatus of claim 16, wherein the at least one selected instruction operand is a first instruction operand and a second instruction operand, and the detector detects that the selected first instruction operand is an instruction operand that is the same in type as an instruction operand of a second operand instruction that is already input to the second selector,
the detector detects that the selected second instruction operand is an instruction operand that is the same in type as an instruction operand of a first instruction operand already input to the first selector, and
the modifier modifies an input path of the selected first instruction operand such that the selected first instruction operand is input to the second selector, and the modifier modifies an input path of the selected second instruction operand such that the selected second instruction operand is input to the first selector, to reduce the type of operand instructions input to the first selector and the second selector.

18. The apparatus of claim 15, wherein the selected instruction operand is a first instruction operand, and the modifier swaps the selected first instruction operand with a second instruction operand to reduce the types of instruction operands that are input to the first selector while still achieving the desired operational result.

19. The apparatus of claim 15, wherein, in response to the second plurality of instruction operands not being input to the second selector, the modifier duplicates the first plurality of instruction operands to generate the second plurality of instruction operands, and the generated second plurality of instruction operands are input to the second selector.

20. The apparatus of claim 19, wherein the modifier modifies a selected first instruction operand with a second operand instruction that corresponds to a duplicate of the selected first instruction operand, to reduce the type of instruction operands that are input to the first selector.
